(19) United States
(12) Patent Application Publication
(10) Pub. No.: US 2014/0279558 A1
(43) Pub. Date: Sep. 18, 2014

(54) Two-Way, Token-Based Validation for NFC-Enabled Transactions

(71) Applicant: ACCENTURE GLOBAL SERVICES, LIMITED, Dublin (IE)

(72) Inventors: Viresh V. Kadi, Bijapur (IN); Rajpreet Singh, Lucknow (IN); Veena S. Padiyar, Boriwali W. Mumbai (IN)

(73) Assignee: ACCENTURE GLOBAL SERVICES, LIMITED, Dublin (IE)

(21) Appl. No.: 13/830,797

(22) Filed: Mar. 14, 2013

(51) Int. Cl. G06Q 20/38; G06Q 20/32

(52) U.S. Cl. CPC G06Q 20/382; G06Q 20/3278
USPC 705/71

(57) ABSTRACT

Systems, methods and computer program products that facilitate the token-based validation of contactless payment and other transactions involving NFC-enabled mobile devices are disclosed. In an aspect, the system includes a server and field-located validator devices to which consumers can present their NFC-enabled mobile devices in order to validate their purchases/payments. In one aspect, a consumer can purchase an admission ticket to a public transport system using their mobile device which communicates directly with the server to receive a token. The user can later present their mobile device to the validator device to actuate a turnstile. Advantageously, the validator devices do not have to be in real-time communication with the server, and limit the duration between the mobile device's request for a token and the time by which the token expires. Increased security is provided through two-way, token-based validation between the mobile and validator devices.

### FIELD OF THE DISCLOSURE

The present disclosure generally relates to near field communications (NFC) and more particularly to systems, methods and computer program products for facilitating the validation of payment and other transactions involving NFC-enabled mobile devices.

### BACKGROUND

The statements in this section merely provide background information related to the present disclosure and may not constitute prior art.

In the last decade, there has been an explosion in the use of mobile electronic devices around the world. Such “mobile devices” include, but are not limited to, personal digital assistants (PDAs), smartphones, mobile (cellular) telephones, tablet computers, notebook computers, laptops, portable media players, handheld game consoles, personal navigation devices and like portable devices. Smartphones, however, make up a significant percentage of today's mobile devices. In fact, various studies show that smartphone penetration is over 25% in the United States, and over 14% worldwide, with the average smartphone user interacting with their device for more than two hours every day.

Also in the last decade, there has been a move to use near field communication (NFC) in a variety of settings. NFC is a set of standards for devices to establish radio communication with each other by touching them together or bringing them within close proximity (e.g., within a few centimeters) of each other. As is well-known in the relevant art(s), NFC is an open platform technology standardized in ECMA-340 and ISO/IEC 18092. These standards specify the modulation schemes, coding, transfer speeds and frame format of the radio frequency (RF) interface of NFC devices, as well as the transport protocol, data-exchange methods, initialization schemes and conditions required for data collision-control during initialization for both passive and active NFC modes.

Given the increased usage of mobile devices and the prevalence of NFC-enabled devices, it is not surprising that NFC-enabled mobile devices (e.g., NFC-enabled smartphones) have gained traction in the past few years as tools of commerce. That is, NFC-enabled mobile devices are now used in “contactless” payment transactions where the mobile device can emulate a traditional credit, charge, debit, pre-paid, stored-value or like financial instrument (plastic) card. This card emulation leverages secure storage in the mobile device and allows mobile payments to replace the traditional “card present” magnetic stripe swiping or card imprint processes.

One problem with mobile “contactless” payments, however, is that not all NFC-enabled devices support card emulation. While mobile devices may have secure storage via a secured element (e.g., a tamper-resistant UICC or microSD chip capable of securely hosting applications and any associated confidential data), they are not easily accessible by third parties other than the OEMs that manufacture the mobile devices or system carriers that provide and control many of the mobile devices.

Further, with the rise of mobile “contactless” payments, there is an associated increase in the potential security risks as mobile devices are easily and quite often lost, as well as being susceptible to cloning, relay attacks and eavesdropping. More specifically, an unauthorized eavesdropper, for example, may intercept the RF signal between a consumer's NFC-enabled mobile device and a merchant's point-of-sale NFC reader.

Given the foregoing, systems, methods, and computer program products are needed that facilitate the validation of contactless payment and other transactions involving NFC-enabled mobile devices that may or may not support card emulation. Such systems, methods, and computer program products should not depend on a mobile device's secure storage while still establishing a secure contactless payment and/or purchase system based on the device's NFC capability.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products for facilitating the mutual, token-based validation of contactless payment and other transactions involving NFC-enabled mobile devices that may or may not support card emulation.

In an aspect, a system for facilitating the validation of contactless payments is disclosed that includes a server and several field-located, merchant NFC readers (i.e., “validator devices”) that users can tap their mobile devices onto in order to validate their purchases/payments. For example, a user can purchase an admission ticket to a public transport system or movie theater using their mobile device which communicates directly with the server. In order to gain admission to the transit system or movie, the user can tap their mobile device on a validator device which actuates a turnstile. Advantageously, the validator device do not have to be in real-time communication with the server, but receive advanced periodic updates of cryptographic data from the server to validate purchase tokens issued by the server to the user's mobile device.

In an aspect, systems, methods, and computer program products which facilitate the validation of contactless payment and other transactions involving NFC-enabled mobile devices provide a generic, token-based alternate to card simulation that is not vendor specific and that is not dependent on the OEM of the NFC-enabled mobile device.

In an aspect, the systems, methods, and computer program products disclosed herein preferably incorporate mutual (i.e., two-way) validation between the NFC-enabled mobile devices and the merchant validator devices. This allows the validator device to validate the mobile device and the mobile device can also validate the validator device to avoid any fraud in the payment or other transaction.

In one aspect, the disclosure provides systems, methods, and computer program products that can be configured to provide support for the purchase and validation of tickets for public transport systems, such as bus, rail and subway. The disclosed system employs an NFC-enabled mobile device that is used to validate a purchased ticket in order to permit passenger passage through, for example, rail turnstiles or bus entry areas.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating the validation of contactless payment and other transactions involving NFC-enabled mobile devices that may or may not support card emulation, according to an aspect of the present disclosure.

FIG. 2 is a data flow diagram of a configuration process for an exemplary system that facilitates the validation of contactless payment and other transactions involving NFC-enabled mobile devices that may or may not support card emulation, according to an aspect of the present disclosure.

FIGS. 3A-3B are a data flow diagram of a two-way, token-based validation process for a contactless payment and other transaction involving an NFC-enabled mobile device that may or may not support card emulation, according to an aspect of the present disclosure.

FIG. 4 is a block diagram of an example computing system useful for implementing the present disclosure.

### DETAILED DESCRIPTION

The present disclosure is directed to systems, methods, and computer program products for facilitating the mutual, token-based validation of contactless payment and other transactions involving NFC-enabled mobile devices that may or may not support card emulation.

Aspects of the present disclosure provide systems, methods, and computer program products which can be used in any context where a purchase/payment transaction is consummated using direct communication between a consumer utilizing an NFC-enabled mobile device (e.g., a smartphone) and a central server, wherein the delivery of goods or services to the consumer is gated at a later time by a validator device, such as a checkout terminal, turnstile or other gating device or mechanism having an NFC reader, that receives a communication from the mobile device. Such aspects eliminate the need for consumers to carry traditional (plastic) or contactless credit/charge/pre-paid/stored-value cards.

Aspects of the present disclosure provide systems, methods, and computer program products that eliminate the need for contactless purchase/payment systems to rely on card emulation normally requiring access to a mobile telephone's secure element for which access is restricted and dependency on OEMs or network service providers to provide access to the secure element.

In other aspects of the present disclosure, the systems, methods and computer program products provided address the possibility of a mobile device being replicated after a purchase is transacted with a server. That is, there may be instances where unauthorized persons replicate (clone) the memory of a consumer's mobile device onto another mobile device. In such instances, both mobile devices could conceivably be used to simultaneously defeat any system that leverages remote validator devices that are not in real-time communication with each other or with a central server. The present disclosure thus limits the duration between the mobile device's request for a token and the time by which the token expires or must be used. By limiting this amount of time, the amount of time during which a device memory could be replicated is also limited and risk of fraud is thereby attenuated.

In another aspect of the present disclosure, the systems, methods and computer program products provided incorporate mutual (i.e., two-way) validation between each of the consumers' mobile devices and any validator device with which they come into NFC communication. That is, the validator device can validate the mobile device and the mobile device can also, in turn, validate the validator device.

Referring now to FIG. 1, a block diagram of an exemplary system 100 for facilitating the validation of contactless payment and other transactions involving NFC-enabled mobile devices that may or may not support card emulation, according to an aspect of the present disclosure, is shown.

Cloud-based, Internet-enabled device communication system 100 includes a plurality of users 102 (shown as users 102a-d in FIG. 1) accessing—via a mobile device 106 (shown as respective mobile devices 106a-d in FIG. 1) and a network 108, such as the global, public Internet—an application service provider's cloud-based, Internet-enabled infrastructure 101. User 102 may access infrastructure 101 in order to facilitate the validation of contactless payment and other transactions when their NFC-enabled mobile devices 106 come within close proximity to one or more (geographically dispersed) validator devices 104 (shown as devices 104a-n in FIG. 1).

As will be appreciated by those skilled in the relevant art(s) after reading the description herein, each validator devices 104 is an on-location checkout terminal, turnstile or other gating device capable of NFC communications with mobile devices 106 preferably loaded with customized firmware to implement the features described herein (e.g., the SCL011 Contactless NFC Desktop Reader available from Indentive Group of Santa Ana, Calif.).

In various aspects, mobile device 106 may be configured as: a mobile telephone 106a; a laptop computer 106b; a Personal Digital Assistant (PDA) or smartphone 106c; a tablet or mobile computer 106d; any commercially-available mobile intelligent communications device; or the like; all of which is enabled to implement NFC communications with any NFC reader.

As shown in FIG. 1, in an aspect of the present disclosure, an application service provider's cloud-based, communications infrastructure 101 may include one or more web servers 110 and one or more application servers 112.

As will be appreciated by those skilled in the relevant art(s) after reading the description herein, in such an aspect, an application service provider—an individual person, business, or other entity—may allow access, on a free registration, paid subscriber and/or pay-per-use basis, to infrastructure 101 via one or more World-Wide Web (WWW) sites on the Internet 108. Thus, system 100 is scalable.

As will also be appreciated by those skilled in the relevant art(s), in an aspect, various screens would be generated by web server 110 in response to input from users 102 over Internet 108. That is, in such an aspect, server 110 is a typical web server running a server application at a website which sends out webpages, while in communications with server 112, in response to Hypertext Transfer Protocol (HTTP) or Hypertext Transfer Protocol Secured (HTTPS) requests from remote browsers on various mobile devices 106 being used by various users 102. Thus, server 110 is able to provide a graphical user interface (GUI) to users 102 of system 100 in the form of webpages. These webpages are sent to the user's mobile devices or the like device 106, and would result in the GUI being displayed.

In alternate aspects, application servers 112 (shown with associated storage in FIG. 1) may be configured to store various modules and data associated with validator device 104 locations, user 102 registration and demographic information, payment information, management information, and the like. In alternate aspects, application servers 112 may comprise one or more data stores within (or remotely located from) infrastructure 101 or be a memory included in (or coupled to) web server(s) 110. That is, in alternate aspects, web servers 110 and application servers 112 may be located on the same physical machines as will be appreciated by those skilled in the relevant art(s) after reading the description herein.

As will be appreciated by those skilled in the relevant art(s) after reading the description herein, alternate aspects of the present disclosure may include providing a tool for facilitating the validation of contactless payment and other transactions involving NFC-enabled mobile devices that may or may not support card emulation as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where users 102 are all customers of the same merchant company (or affiliated companies), the present disclosure may be implemented as a stand-alone system, rather than as a web service (e.g., Application Service Provider (ASP) model utilized by various unassociated/unaffiliated users and merchants) as shown in FIG. 1.

As will also be appreciated by those skilled in the relevant art(s) after reading the description herein, alternate aspects of the present disclosure may include providing the tools for facilitating the validation of contactless payment and other transactions involving NFC-enabled mobile devices that may or may not support card emulation via an installed application, a browser pre-installed with an applet or a browser with a separately downloaded applet on mobile devices 106. That is, as will also be apparent to one skilled in the relevant art(s) after reading the description herein, an applet that facilitates the token-based solution of the present disclosure disclosed herein may be part of the “standard” browser that ships with mobile device 106 or may be later added to an existing browser as part of an “add-on,” or “plug-in,” or may be added as a separate mobile application software (app) capable of executing on mobile device 106 after an “app store download.”

In one aspect, system 100 and its accompanying methods and computer program products of the present disclosure is configured to provide support for the purchase and validation of tickets for movies or public transport systems such as bus, rail and subway. Thus, the present disclosure is now described in more detail herein in terms of the above exemplary context. This is for convenience only and is not intended to limit the application of the present disclosure. In fact, after reading the following description, it will be apparent to one skilled in the relevant art(s) how to implement the following disclosure in alternative embodiments (e.g., any context where a purchase/payment is consummated using direct communication between a mobile device 106 and a server 110, and wherein the delivery of goods or services to the consumer/purchaser is gated at a later time by a validator device 104 that receives NFC-based communications from mobile device 106).

The terms “user,” “consumer”, “customer,” and/or the plural form of these terms are used interchangeably throughout herein to refer to those persons or entities capable of accessing, using, be affected by and/or benefiting from the tool that the present disclosure provides for facilitating the mutual, token-based validation of contactless payment and other transactions involving NFC-enabled mobile devices.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a movie theater, a public transportation agency, a grocery store, a retail store, a travel agency, a service provider, an on-line merchant or the like.

Referring now to FIG. 2, a data flow diagram of a configuration process 200 for an exemplary system that facilitates the mutual, token-based validation of contactless payment and other transactions involving NFC-enabled mobile devices, according to an aspect of the present disclosure, is shown. The following description of process 200 includes references to the generation of “keys.” As will be appreciated by those skilled in the relevant art(s), there are various techniques and algorithms well known in the arts that may be used to randomly generate variable-length cryptographic keys that determine the functional output of a cryptographic algorithm or cipher. Thus, it will be apparent to such persons skilled in the relevant art(s) that various changes in form and detail can be made in various aspects of process 200 without departing from the spirit and scope of the present disclosure.

In such an aspect, application servers 112 include a registration service 202, a day keys generator service 204, and a time slot keys generator service 206.

In one aspect, registration service 202 found within application servers 112 allows a user 102 utilizing a mobile software application (or “app”) executing on mobile device 106 to register themselves before conducting purchase and other transactions with a business within system 100. In such an aspect, the app executing on mobile device 106 includes a registration component 212 that allows user 102 to register with server 112. During the registration process, user 102 sends a self-defined username and password to registration service 202. Registration service 202 on application server 112 then generates an Application ID (“AppID”) that is uniquely associated with user 102 and stores the AppID along with the user's credentials (e.g., username, password, financial account information and the like) within an AppID database 216 on application servers 112. Upon successful registration, registration service 202 sends a message to registration component 212. Now, user 102 can perform purchase or other transactions such as, for example, buying a ticket.

In one aspect, day keys generator service 204 found within application servers 112 is responsible for generating a unique day key for each day system 100 is in operation. Such defined day keys are then stored on server 112 within a day keys database 214. The day keys are then periodically synchronized to one or more validator devices 106 (e.g., once per day, twice per day, every six hours, etc.) and stored locally within a day key database 210 on one or more validator devices 106.

In one aspect, time slot keys generator service 206 found within application servers 112 is responsible for defining unique time slots for each day system 100 is in operation. Such time slots are customizable according to the merchant(s) employing system 100 and may be, for example, hourly, half-hourly, quarter-hourly or may correspond to movie times, bus/rail schedules and the like. Such defined time slots are then stored on application servers 112 within a time slot database 218.

Time slot keys generator service 206 is also responsible for generating unique time slot keys, assigning them to the defined time slots and storing them on application servers 112 within a time slot keys database 220. The time slot keys are periodically synchronized to all validator devices 106 (e.g., once per day, twice per day, every six hours, etc.) and stored locally within a time slot key database 208 on each of the validator devices 106.

As will be appreciated by those skilled in the relevant art(s) after reading the description herein, configuration process 200 in an alternate aspect may simply use one periodically-generated, time-based key (e.g., a single day key, a single time slot key, a single day/time key combining day and time values, and the like).

Once process 200 terminates, user 102 can then perform purchase or other transactions such as, for example, buying a ticket for an event and then later presenting mobile device 106 to validator device 104 for admission to the purchased event. This advantageously eliminates the need for consumers (i.e., users 102) to carry traditional (plastic) or contactless credit/charge/pre-paid/stored-value cards.

We now refer to FIGS. 3A-3B, which collectively show a data flow diagram of a process 300 for performing two-way, token-based validation of a contactless payment and other transaction involving an NFC-enabled mobile device 106, according to an aspect of the present disclosure. The following description of process 300 includes general references to hash code generation, encryption, decryption, concatenation, random number generation and like data manipulation operations. As will be appreciated by those skilled in the relevant art(s), there are various techniques and algorithms well known in the arts that may be used to accomplish such operations. Thus, it will be apparent to such persons skilled in the relevant art(s) that various changes in form and detail can be made in various aspects of process 300 without departing from the spirit and scope of the present disclosure.

In one aspect, application server 112 further includes a token generation service 302 which allows user 102 to initiate the token transfer process between server 112 and mobile device 106 for eventual presentation/authentication via NFC communications with a validator device 104. That is, in such an aspect, user 102 would engage a buy ticket component 312 within the app executing on mobile device 106 (via a GUI, voice commands and the like) in order to purchase a ticket for a movie, a show, a sporting event, a public transport system ride (such as bus, rail or subway), and the like.

In a step 320, upon HTTPS communications initiated from mobile device 106 via the Internet 108 and web server 110, token generation service 302 generates a time-based token (“TBT”). In one aspect, the TBT is generated by concatenating a day key retrieved from day key database 214, a time slot key retrieved from time slot key database 220, and the user's AppID (which was initially generated by registration service 202 when user 102 registered with system 100 and stored in AppID database 216).

As mentioned above, process 300 makes use of two time-based cryptographic keys (i.e., the day key and the time slot key) when generating the TBT. This is for added security. As will be appreciated by those skilled in the relevant art(s) after reading the description herein, however, process 300 (like process 200) in an alternate aspect may simply use one time-based key when generating the TBT (e.g., a single day key, a single time slot key, or a single day/time key combining day and time values). In fact, in one aspect, the use of a day key may be eliminated altogether, and the time slot key can be solely relied upon, wherein each time slot key is associated with a respective time slot of a sequence of time slots that may span any number of days. In certain aspects, the day key can also be included and relied upon to increase security by way of including yet another degree of complexity to guard against a hacker seeking to defeat system 100. The day key, however, is not required in all implementations.

Returning to FIG. 3, in step 322, token generation service 302 generates an Identity Token by using the day key and time slot key to encrypt the concatenation of the AppID and a randomly-generated Mobile Random Number associated with user 102. Then, in step 324, a hash function is applied to the reverse of the Mobile Random Number to create a hash value denoted as “#RMR” in FIG. 3.

In step 326, a unique product information identification number (e.g., a UPC code denoted as “ProductInfo” in FIG. 3 or the like) is assigned to the ticket for a movie, a show, a sporting event, a public transport system ride, or the like that user 102 is attempting to purchase. The ProductInfo value is then concatenated with the Mobile Random Number and encrypted by token generation service 302—the resulting encrypted value denoted as the “EnProdInfo” in FIG. 3.

In one aspect, at the conclusion of steps 320-326, token generation service 302, via web server 110, sends the TBT, Identity Token, #RMR and EnProdInfo values (one or more of which may be collectively referred to as an “electronic ticket”) to buy ticket component 312 on mobile device 106 via HTTP(S) communications over the Internet 108.

At some point in time after the conclusion of steps 320-326, but before the expiration of the TBT, user 102 presents their mobile device 106 to a validator device 104 (i.e., user 102 causes their NFC-enabled mobile device 106 to come within close proximity to one of a plurality of geographically-dispersed validator devices 104, such as a merchant point of sale NFC readers) in step 328, as an electronic ticket. Then, two-way, token-based validation of a contactless payment and other transactions process 300 continues to step 330.

In step 330, an authentication module 304 executing on validator device 104 initiates a “handshake” authentication of mobile device 106 by requesting mobile device 106 to identify itself. This causes, in an aspect and step 332, a mobile verification component 310 within the app executing on mobile device 106 to send the Identity Token (generated in step 322) to validator device 104 in order to begin to validate the ticket purchased by buy ticket component 312.

In step 334, validator device 104 decrypts the Identity Token using the day key and the time slot key. As will be appreciated by those skilled in the relevant art(s) after reading the description herein, the day key is stored locally within day key database 210 on validator devices 104 because there are periodically synchronized from the day keys stored on server 112 within day keys database 214. Similarly, the time slot key is stored locally within time slot key database 208 on validator devices 106 because there are periodically synchronized from the time slot keys stored on server 112 within time slot keys database 220. As a result of step 334, validator device 104 extracts the Mobile Random Number and the AppID from the Identity Token sent by mobile device 106 over NFC communications.

In step 336, validator authentication module 304 generates a time-based token (“TBT”). In one aspect, the TBT is generated by concatenating the day key retrieved from day key database 210, the time slot key retrieved from time slot key database 208, and the user's AppID (as in step 320).

In step 338, validator authentication module 304 generates a randomly-generated Validator Random Number (“VR”) associated with validator device 104.

In step 340, validator authentication module 304 applies a hash function to the reverse of the Mobile Random Number extracted in step 334 to create a hash value denoted as #RMR1 in FIG. 3.

In step 342, validator authentication module 304 generates a n-length value by jumbling the n-digit VR and the n-digit #RMR1 values (i.e., VR₁, #RMR1₁, VR₂, #RMR1₂, VR₃, #RMR1₃ . . . VRₙ, #RMR1ₙ). Then, in step 344, the jumbled n-digit value is encrypted using the TBT generated in step 336 and sent, via NFC communications, to mobile verification component 310 executing on mobile device 106.

In step 346, mobile verification component 310 decrypts the jumbled n-digit value received from validator authentication module 304 using the TBT received from server 112 after the conclusion of steps 320-326. As a result, a validator random number (“VR1”) and the hash of the reversed mobile random number (“#RMR1”) are extracted. Then, in step 348, mobile verification component 310 compares the extracted #RMR1 with the #RMR received from application server 112 after the conclusion of steps 320-326. If the values do not match, mobile device 106 discards the authentication request from validator device 104 and process 300 ends. Otherwise, in step 352, mobile verification component 310 applies a hash function to the VR1 value, encrypts it using the TBT and sends the resulting value (“En[#VR1]”) to validator authentication module 304 via NFC communications.

In step 354, validator authentication module 304 decrypts the En[#VR1] value received from mobile verification component 310 using the TBT, thereby extracting a #VR1 value.

In step 356, mobile verification component 310 applies a hash function to the VR value generated in step 338 (“#VR”) and compares it to the #VR1 value extracted in step 354. If the values do not match, validator device 104 discards the authentication request from mobile device 106 and process 300 ends. Otherwise, in step 360, authentication module 304 completes the “handshake” authentication of mobile device 106 and sends a request to mobile device 106 to obtain the ProdutInfo value.

In step 362, a send product component 308 within the app executing on mobile device 106 sends the EnProdInfo value to a ticket processor component 306 on validator device 104 via NFC communications.

In step 364, ticket processor component 306 decrypts the EnProdInfo value to extract the ProductInfo value. Then, in step 366, ticket processor component 306 processes the ticket based on the product information (ProductInfo) received from mobile device 106. Such processing includes, in alternate aspects, delivering of goods or services to user 102 in a gated fashion (i.e., at the merchant point of sale pay terminal or point of service turnstile). Process 300—which eliminates the need for consumers to carry traditional (plastic) or contactless credit/charge/pre-paid/stored-value cards and also eliminates the need for contactless purchase/payment systems to rely on card emulation normally requiring access to the secured element of mobile device 106—then terminates.

As will be appreciated by those skilled in the relevant art(s) after reading the description herein, process 300 provides a generic, token-based alternate to card simulation. This eliminates the need for contactless purchase/payment systems to rely on card emulation, which normally requires access to the secure element on mobile device 106 (for which access is typically restricted and dependent on an OEM or a network service provider to provide such access).

Referring now to FIG. 4, a block diagram of an exemplary computer system useful for implementing various aspects the processes disclosed herein, in accordance with one or more aspects of the present disclosure, is shown. That is, FIG. 4 sets forth illustrative computing functionality 400 that may be used to implement web server 110, one or more application servers 112, validator devices 104, mobile devices 106 utilized by users 102 to access Internet 108, or any other component of system 100. In all cases, computing functionality 400 represents one or more physical and tangible processing mechanisms.

Computing functionality 400 may comprise volatile and non-volatile memory, such as RAM 402 and ROM 404, as well as one or more processing devices 406 (e.g., one or more central processing units (CPUs), one or more graphical processing units (GPUs), and the like). Computing functionality 400 also optionally comprises various media devices 408, such as a hard disk module, an optical disk module, and so forth. Computing functionality 400 may perform various operations identified above when the processing device(s) 406 executes instructions that are maintained by memory (e.g., RAM 402, ROM 404, and the like).

More generally, instructions and other information may be stored on any computer readable medium 410, including, but not limited to, static memory storage devices, magnetic storage devices, and optical storage devices. The term “computer readable medium” also encompasses plural storage devices. In all cases, computer readable medium 410 represents some form of physical and tangible entity. By way of example, and not limitation, computer readable medium 410 may comprise “computer storage media” and “communications media.”

“Computer storage media” comprises volatile and non-volatile, removable and non-removable media implemented in any method or technology for storage of information, such as computer readable instructions, data structures, program modules or other data. Computer storage media may be, for example, and not limitation, RAM 402, ROM 404, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 400 may also comprise an input/output module 412 for receiving various inputs (via input modules 414), and for providing various outputs (via one or more output modules). One particular output mechanism may be a presentation module 416 and an associated GUI 418. Computing functionality 400 may also include one or more network interfaces 420 for exchanging data with other devices via one or more communication conduits 422. In some aspects, one or more communication buses 424 communicatively couple the above-described components together.

Communication conduit(s) 422 may be implemented in any manner (e.g., by a local area network, a wide area network (e.g., the Internet), and the like, or any combination thereof). Communication conduit(s) 422 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “service,” “module” and “component” as used herein generally represent software, firmware, hardware or combinations thereof. In the case of a software implementation, the service, module or component represents program code that performs specified tasks when executed on one or more processors. The program code may be stored in one or more computer readable memory devices, as described with reference to FIG. 4. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A system for facilitating the two-way, token-based validation of a near field communications (NFC)-enabled transaction, the system comprising:
at least one web server capable of providing a graphical user interface, via a communications network, to a plurality of NFC-enabled mobile devices, and communicatively coupled, via said communications network, to a plurality of validator devices; and
at least one application server, coupled to said at least one web server, said at least one application server comprising:
a time slot database comprising a plurality of time slots for a plurality of days;
a time slot key generator service capable of generating a plurality of time slot keys, each corresponding to one of said plurality of time slots;
a time slot keys database comprising said plurality of time slot keys generated by said time slot key generator service;
a registration service capable of generating a plurality of unique identification numbers, each corresponding to one of said plurality of NFC-enabled mobile devices;
an identification database comprising said plurality of unique identification numbers generated by said registration service; and
a token generation module capable of generating a plurality of time-based tokens, each is generated using one of said plurality of time slot keys and one of said plurality of unique identification numbers;
wherein said at least one application server facilitates a transaction when one of said plurality of NFC-enabled mobile devices is presented to one of said plurality of validator devices, wherein said transaction is secured by a two-way authentication based upon one of said plurality of time-based tokens.

2. The system of claim 1, wherein said communications network is the global, public Internet; and said at least one web server communicates with said plurality of NFC-enabled mobile devices and said plurality of validator devices via the Hypertext Transfer Protocol Secured (HTTPS) protocol.

3. The system of claim 2, wherein at least one of said plurality of NFC-enabled mobile devices is a smartphone.

4. The system of claim 1, further comprising:
a day key generator service capable of generating a plurality of day keys, each corresponding to one of said plurality of days; and
a day keys database comprising said plurality of day keys generated by said day key generator service;
wherein said token generation module is further capable of generating said plurality of time-based tokens using said plurality of day keys, said plurality of time slot keys, and said plurality of unique identification numbers.

5. The system of claim 4, wherein said at least one application server is configured to periodically synchronize said time slot keys database and said day keys database to at least one of said plurality of validator devices over said communications network.

6. The system of claim 5, wherein said token generation module is further capable of:
sending, via said communications network, one of said plurality of time-based tokens to one of said plurality of NFC-enabled mobile devices in response to a request by said one of said plurality of NFC-enabled mobile devices to conduct said transaction.

7. The system of claim 6, wherein said token generation module is further capable of:
generating a plurality of identity tokens, each is formed by encrypting one of said plurality of day keys, one of said plurality of time slot keys, and one of said plurality of unique identification numbers; and
sending, via said communications network, one of said plurality of identity tokens to said one of said plurality of NFC-enabled mobile devices in response to said request by said one of said plurality of NFC-enabled mobile devices to conduct said transaction.

8. The system of claim 7, wherein said token generation module is further capable of:
encrypting a plurality of unique product information identification numbers; and
sending, via said communications network, one of said plurality of unique product information identification numbers to said one of said plurality of NFC-enabled mobile devices in response to said request by said one of said plurality of NFC-enabled mobile devices to conduct said transaction.

9. A method for facilitating the two-way validation of electronic tickets in order to provide a person access to a system, good, service or location, the method comprising the steps of:
generating, by a server, at least one cryptographic key;
sending, by said server and via a communications network, said cryptographic key to a plurality of validator devices;
generating, by said server and in response to receiving a request for a ticket from a mobile device, an electronic ticket based on said cryptographic key;
sending, by said server, said electronic ticket to said mobile device;
receiving, at one of said plurality of validator devices, authentication data from said mobile device as a result of said mobile device being brought within close proximity of said one of said plurality of validator devices by the person, wherein said authentication data is based on said cryptographic key;
validating, by said one of said plurality of validator devices, said authentication data received from said mobile device based on said cryptographic key;
sending, by said one of said plurality of validator devices in response to validating said authentication data, a request for said electronic ticket;
receiving, by said one of said plurality of validator devices, an electronic transmission based upon said electronic ticket from said mobile device when said mobile device authenticates said request based on said cryptographic key;
validating, by said one of said plurality of validator devices in response to said electronic transmission, said electronic ticket based on said cryptographic key; and
providing the person access to the system, good, service or location in response to validating said electronic ticket.

10. The method of claim 9, wherein said communications network is the global, public Internet and said mobile device and said one of said plurality of validator devices communicate via near field communications (NFC) signals.

11. The method of claim 10, wherein said mobile device is an NFC-enabled smartphone.

12. The system of claim 11, wherein said server communicates with said mobile device and said plurality of validator devices via the Hypertext Transfer Protocol Secured (HTTPS) protocol.

13. A method for generating and validating electronic tokens, the method comprising the steps of:
associating, by a server, each one of a plurality of cryptographic keys with one of a plurality of time periods;
transmitting, by said server, said plurality of cryptographic keys to each of a plurality of disparately-located validator devices;
generating, by said server in response to receiving a request from a mobile device during one of said plurality of time periods, a first electronic token, wherein said first electronic token is based upon one of said plurality of cryptographic keys associated with one of said plurality of time periods relevant to when said request was received;
sending, by said server, said first electronic token to said mobile device;
receiving, at one of said plurality of validator devices, a transmission of said first electronic token from said mobile device, wherein said transmission results from bringing said mobile device within close proximity to said one of said plurality of validator devices; and
validating, by said one of said plurality of validator devices, said first electronic token based on said one of said plurality of cryptographic keys associated with said one of said plurality of time periods.

14. The method of claim 13, further comprising the step of:
generating, by said server in further response to receiving said request from said mobile device, a second electronic token, wherein said second electronic token is based upon one of said plurality of cryptographic keys associated with one of said plurality of time periods relevant to when said request was received;
sending, by said server, said second electronic token to said one of said plurality of validator devices;
generating, also by said one of said plurality of validator devices, said second electronic token, wherein said second electronic token is based upon one of said plurality of cryptographic keys associated with one of said plurality of time periods relevant to when said request was received;
generating, by said one of said plurality of validator devices, a third electronic token based upon said second electronic token and a random data element; and
sending, by said one of said plurality of validator devices, said third electronic token to said mobile device; thereby facilitating said mobile device validating said third electronic token using said second electronic token previously by said mobile device received from said server.

15. The method of claim 14, further comprising the steps of:
receiving, by said one of said plurality of validator devices, a fourth electronic token generated by said mobile device using said second electronic token and said third electronic token; and
validating, by said one of said plurality of validator devices, said fourth electronic token based on said second electronic token and said random data element.

16. The method of claim 13, wherein said server receives said request from said mobile device after said server transmits said plurality of cryptographic keys to each of said plurality of validator devices.

17. The method of claim 13, wherein each of said time periods occurs within a total duration of at most twenty-four hours.

18. One or more computer storage media having stored thereon multiple instructions that implement a two-way, token-based validation of contactless transaction component by, when executed by one or more processors of a computing device, causing the one or more processors to:
provide a graphical user interface, via a communications network, to a plurality of NFC-enabled mobile devices;
store a plurality of time slots for a plurality of days in a time slot database;
generate a plurality of time slot keys, each corresponding to one of said plurality of time slots;
store said plurality of time slot keys in a time slot keys database;
generate a plurality of unique identification numbers, each corresponding to one of said plurality of NFC-enabled mobile devices;
store said plurality of unique identification numbers in an identification database;
generate a plurality of time-based tokens, each is generated using one of said plurality of time slot keys and one of said plurality of unique identification numbers; and
facilitate a transaction when one of said plurality of NFC-enabled mobile devices is presented to one of said plurality of validator devices, wherein said transaction is secured by a two-way authentication based upon one of said plurality of time-based tokens.

19. One or more computer storage media as recited in claim 18, wherein said communications network is the global, public Internet; and said GUI is provided to said plurality of NFC-enabled mobile devices via the Hypertext Transfer Protocol Secured (HTTPS) protocol.

20. One or more computer storage media as recited in claim 18, wherein at least one of said plurality of NFC-enabled mobile devices is a smartphone.

21. One or more computer storage media as recited in claim 18, wherein the multiple instructions further cause the one or more processors to:
periodically synchronize said time slot keys database to at least one of said plurality of validator devices over said communications network.

22. One or more computer storage media as recited in claim 21, wherein the multiple instructions further cause the one or more processors to:
send, via said communications network, one of said plurality of time-based tokens to one of said plurality of NFC-enabled mobile devices in response to a request by said one of said plurality of NFC-enabled mobile devices to conduct said transaction.

23. One or more computer storage media as recited in claim 22, wherein the multiple instructions further cause the one or more processors to:
generate a plurality of identity tokens, each is formed by encrypting one of said plurality of time slot keys and one of said plurality of unique identification numbers; and
send, via said communications network, one of said plurality of identity tokens to said one of said plurality of NFC-enabled mobile devices in response to said request by said one of said plurality of NFC-enabled mobile devices to conduct said transaction.

24. One or more computer storage media as recited in claim 23, wherein the multiple instructions further cause the one or more processors to:
encrypt a plurality of unique product information identification numbers; and
send, via said communications network, one of said plurality of unique product information identification numbers to said one of said plurality of NFC-enabled mobile devices in response to said request by said one of said plurality of NFC-enabled mobile devices to conduct said transaction.
